(19) United States
(12) Patent Application Publication
(10) Pub. No.: US 2026/0320130 A1
(43) Pub. Date: Oct. 15, 2026

(54) DISCUSSION SUPPORT DEVICE, DISCUSSION SUPPORT METHOD, AND RECORDING MEDIUM

(71) Applicant: NEC Corporation, Tokyo (JP)

(72) Inventors: Shinji CHICHIBU, Tokyo (JP); Nozomi TABATA, Tokyo (JP)

(73) Assignee: NEC Corporation, Tokyo (JP)

(21) Appl. No.: 19/637,048

(22) Filed: Apr. 2, 2026

(30) Foreign Application Priority Data
Apr. 15, 2025 (JP) 2025-066788

(51) Int. Cl. G06F 16/9035; G06F 16/903

(52) U.S. Cl. CPC G06F 16/9035; G06F 16/90335

(57) ABSTRACT

In order to utilize an outcome of a discussion using a plurality of generative AIs and obtained information regarding the generative Ais, a processor of a discussion support device that is communicably connected to a plurality of generative Ais acquires setting information set by a user for a discussion. The processor records the setting information, and activates the plurality of generative AIs based on the setting information and causing the plurality of generative AIs to conduct the discussion. The processor analyzes the setting information, and creates and outputs recommended information to be recommended to the user.

### INCORPORATION BY REFERENCE

This application is based upon and claims the benefit of priority from Japanese Patent Application 2025-066788, filed on Apr. 15, 2025, the disclosure of which is incorporated herein in its entirety by reference.

### TECHNICAL FIELD

The present disclosure relates to a technology utilizing generative artificial intelligence (AI).

### BACKGROUND ART

In recent years, introduction of a system that generates an outcome a user wants by utilizing a plurality of generative AIs has progressed. With development of such a system, an environment that makes it possible to flexibly fulfill multiple users' needs is being put into place. Patent Document 1 discloses a system in which an answer device having a plurality of large language models (LLMs) appropriately answers a user's request.

Patent Document 1: Patent Document 1: Japanese Patent No. 7588752

### SUMMARY

In a case where a plurality of generative AIs is used, it is possible to refer to an outcome of using the plurality of generative AIs and obtained information regarding the generative AIs. It is desirable to make a better system in a case where a generative AI is used next time, by utilizing these pieces of information.

One object of the present disclosure is to provide a discussion support device capable of utilizing an outcome of a discussion using a plurality of generative AIs and obtained information regarding the generative AIs.

According to an example aspect of the present invention, there is provided a discussion support device that is communicably connected to a plurality of generative AIs, the discussion support device including:
at least one memory configured to store instructions; and
at least one processor configured to execute the instructions to:
acquire setting information set by a user for a discussion;
record the setting information;
activate the plurality of generative AIs based on the setting information and causing the plurality of generative AIs to conduct the discussion; and
analyze the setting information, and create and output recommended information to be recommended to the user.

According to another example aspect of the present invention, there is provided a discussion support method executed by a discussion support device communicably connected to a plurality of generative AIs, the discussion support method including:
acquiring setting information set by a user for a discussion;
recording the setting information;
activating the plurality of generative AIs based on the setting information and causing the plurality of generative AIs to conduct the discussion; and
analyzing the setting information, and creating and outputting recommended information to be recommended to the user.

According to still another example aspect of the present invention, there is provided a non-transitory computer-readable recording medium storing a program executed by a discussion support device that is communicably connected to a plurality of generative AIs and includes a computer, the program causing the computer to execute processing including:
acquiring setting information set by a user for a discussion;
recording the setting information;
activating the plurality of generative AIs based on the setting information and causing the plurality of generative AIs to conduct the discussion; and
analyzing the setting information, and creating and outputting recommended information to be recommended to the user.

### EFFECT

According to the present disclosure, it is possible to provide a discussion support device capable of utilizing an outcome of a discussion using a plurality of generative AIs and obtained information regarding the generative AIs.

### BRIEF DESCRIPTION OF THE DRAWINGS

FIG. 1 illustrates an example of a schematic configuration of a discussion support system according to the present disclosure;

FIGS. 2A and 2B are block diagrams illustrating examples of hardware configurations of a server and a user terminal;

FIG. 3 is a block diagram illustrating an example of a functional configuration of the server;

FIGS. 4A and 4B illustrate examples of a setting screen;

FIG. 5 illustrates remark examples of respective generative AIs;

FIG. 6 illustrates an example of an outcome screen;

FIG. 7 is an example of the setting screen displaying recommended information;

FIGS. 8A and 8B illustrate examples of the recommended information;

FIG. 9 is a flowchart illustrating an example of recommended information creation processing by the server;

FIG. 10 is a block diagram illustrating a functional configuration of a discussion support device; and

FIG. 11 is a flowchart by the discussion support device.

### EXAMPLE EMBODIMENTS

Hereinafter, example embodiments of the present disclosure will be described with reference to the drawings.

### First Example Embodiment

### Overall Configuration

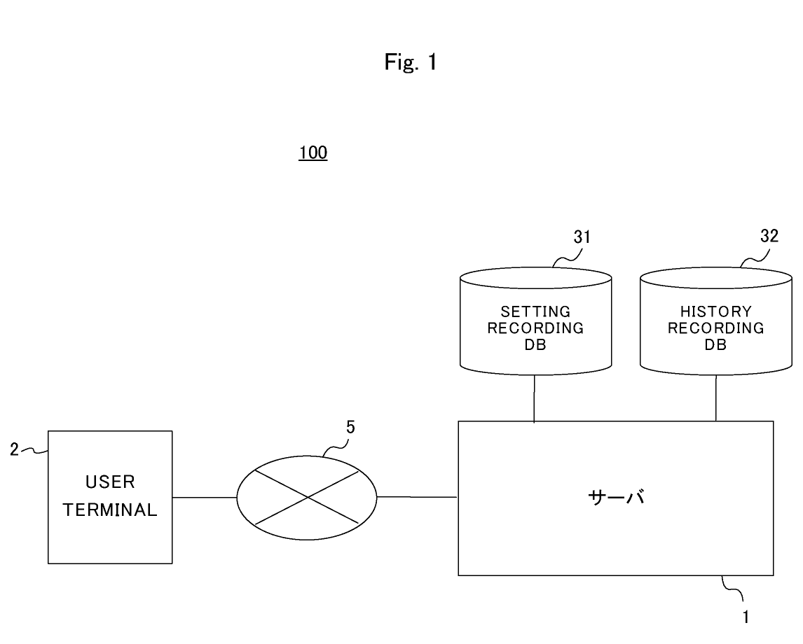

FIG. 1 illustrates an example of a schematic configuration of a discussion support system 100 to which a discussion support device of the present disclosure is applied. The discussion support system 100 is a system capable of utilizing an outcome of a discussion using a plurality of generative AIs and obtained information regarding the generative AIs. Specifically, the discussion support system 100 can clarify selection criteria for a generative AI to be used in a next discussion, by providing recommended information to a user based on the information obtained by the discussion using the plurality of generative AIs. The discussion is a discussion among a plurality of persons for the purpose of exchanging opinions or solving a problem, and includes a debate in the form of vigorous exchange of opposing opinions.

In the discussion support system 100 in FIG. 1, a server 1 and a user terminal 2 are communicably connected via a network 5 such as the Internet. The user is a person who receives an outcome of the discussion utilizing the generative AIs.

The user terminal 2, which is a smartphone, a tablet, a PC, or the like used by the user, transmits, to the server 1, setting information such as a theme of the discussion, generative AIs to be used, and a character to be set, and receives recommended information from the server 1.

The server 1 is an information processing apparatus that performs processing on, and storage and transmission and reception of various types of data, and receives the setting information from the user terminal 2 and transmits the recommended information to the user terminal 2. The server 1 is connected to a history recording DB 31 and a setting recording DB 32 to be described later. The server 1 may be a virtual server present in a cloud environment. The server 1 is an example of the discussion support device of the present disclosure.

### Hardware Configuration

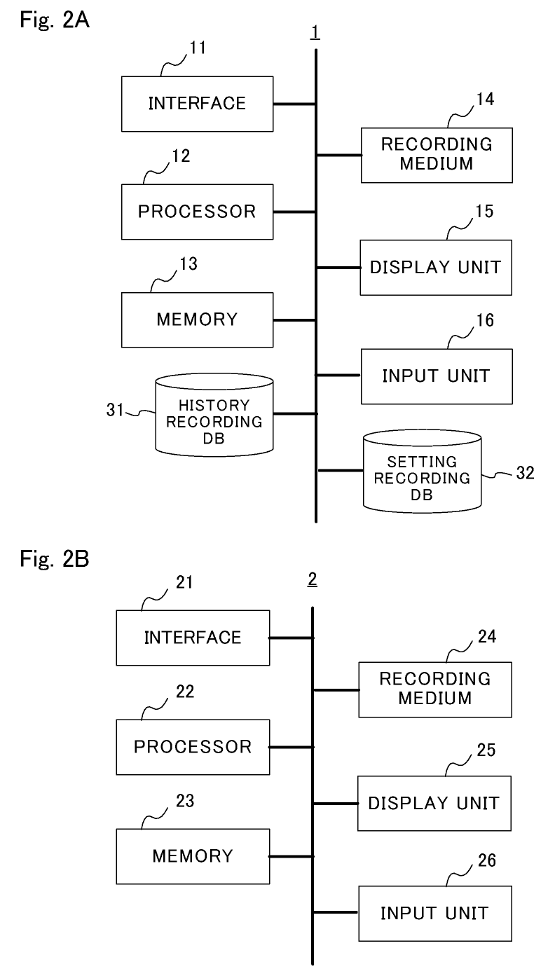

FIG. 2A is a block diagram illustrating an example of a hardware configuration of the server 1. As illustrated in the drawing, the server 1 includes an interface 11, a processor 12, a memory 13, a recording medium 14, a display unit 15, and an input unit 16. These components and the history recording DB 31 and the setting recording DB 32 are connected to each other via a bus.

The interface 11 exchanges data with the user terminal 2. The interface 11 is used to receive the setting information from the user terminal 2, and transmit the recommended information to the user terminal 2.

The processor 12 is a computer such as a central processing unit (CPU), and controls the entire server 1 by executing a program prepared in advance. As the processor 12, it is possible to use a CPU, a graphics processing unit (GPU), a digital signal processor (DSP), a micro processing unit (MPU), a Floating Point Unit (FPU), a physics processing unit (PPU), a tensor processing unit (TPU), a quantum processor, a microcontroller, a combination of these, or the like.

The memory 13 includes a read only memory (ROM), a random access memory (RAM), and the like. The memory 13 stores a program to be executed by the processor 12. The memory 13 is also used as a working memory during execution of various types of processing by the processor 12.

The recording medium 14 is a non-volatile and non-transitory recording medium such as a disk-shaped recording medium or a semiconductor memory, and is attachable to and detachable from the server 1. The recording medium 14 records various programs to be executed by the processor 12. In order for the server 1 to execute recommended information creation processing, which will be described later, a program recorded on the recording medium 14 is loaded into the memory 13 and is executed by the processor 12.

The display unit 15 is, for instance, a liquid crystal display (LCD), and displays various images during an operation of the server 1. The input unit 16 is a keyboard, a mouse, a touch panel, or the like, and is used by an operator who manages the server 1.

The history recording DB 31 records the contents of remarks of each generative AI in a discussion utilizing a plurality of generative AIs. Specifically, the history recording DB 31 records, as history information, AI identification information for identifying the generative AIs used for the discussion, a character that is set for each generative AI, remarks of each generative AI and times at which the remarks were made, and the like. The history information may be recorded in association with a theme of the discussion and user identification information for identifying the user. The information to be recorded in the history recording DB 31 can be freely set.

The setting recording DB 32 records the setting information set by the user in a discussion utilizing a plurality of generative AIs. Specifically, the setting recording DB 32 records, as the setting information, a theme of the discussion, AI identification information of the generative AIs used for the discussion, a character that is set for each generative AI, and the like. The setting information may be recorded including user identification information, the degree of satisfaction of the discussion, and the degree of contribution of each generative AI. The information to be recorded in the setting recording DB 32 can be freely set.

FIG. 2B is a block diagram illustrating an example of a hardware configuration of the user terminal 2. As illustrated, the user terminal 2 includes an interface 21, a processor 22, a memory 23, a recording medium 24, a display unit 25, and an input unit 26.

The interface 21 exchanges data with the server 1 via the network 5. The interface 21 is used to transmit the setting information set by the user to the server 1 and receive the recommended information from the server 1.

The processor 22 is a computer, such as a CPU, and controls the entire user terminal 2 by executing a program prepared in advance. As the processor 22, it is possible to use a CPU, a GPU, a DSP, an MPU, an FPU, a PPU, a TPU, a quantum processor, a microcontroller, a combination of these, or the like.

The memory 23 includes, for instance, a ROM and a RAM. The memory 23 stores a program to be executed by the processor 22. The memory 23 is also used as a working memory during execution of various types of processing by the processor 22.

The recording medium 24 is a non-volatile non-transitory recording medium such as a disk-shaped recording medium or a semiconductor memory, and is attachable to and detachable from the user terminal 2. The recording medium 24 records various programs to be executed by the processor 22. The display unit 25 is, for instance, an LCD, and displays various images while the user is operating the user terminal 2. The input unit 26 is, for instance, a touch panel and is used by the user to perform a predetermined operation.

### Functional Configuration

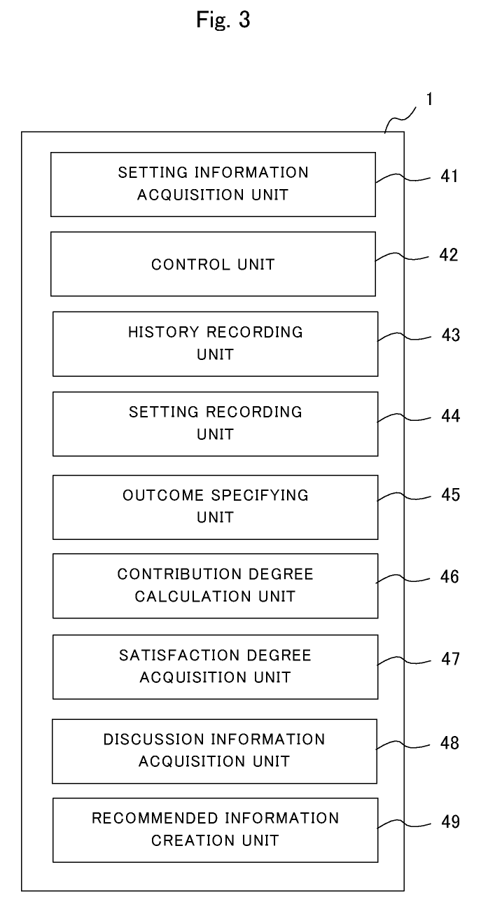

FIG. 3 is a block diagram illustrating an example of a functional configuration of the server 1. The server 1 functionally includes a setting information acquisition unit 41, a control unit 42, a history recording unit 43, a setting recording unit 44, an outcome specifying unit 45, a contribution degree calculation unit 46, a satisfaction degree acquisition unit 47, a discussion information acquisition unit 48, and a recommended information creation unit 49.

The setting information acquisition unit 41, the control unit 42, the history recording unit 43, the setting recording unit 44, the outcome specifying unit 45, the contribution degree calculation unit 46, the satisfaction degree acquisition unit 47, the discussion information acquisition unit 48, and the recommended information creation unit 49 are implemented by the processor 12 executing a program.

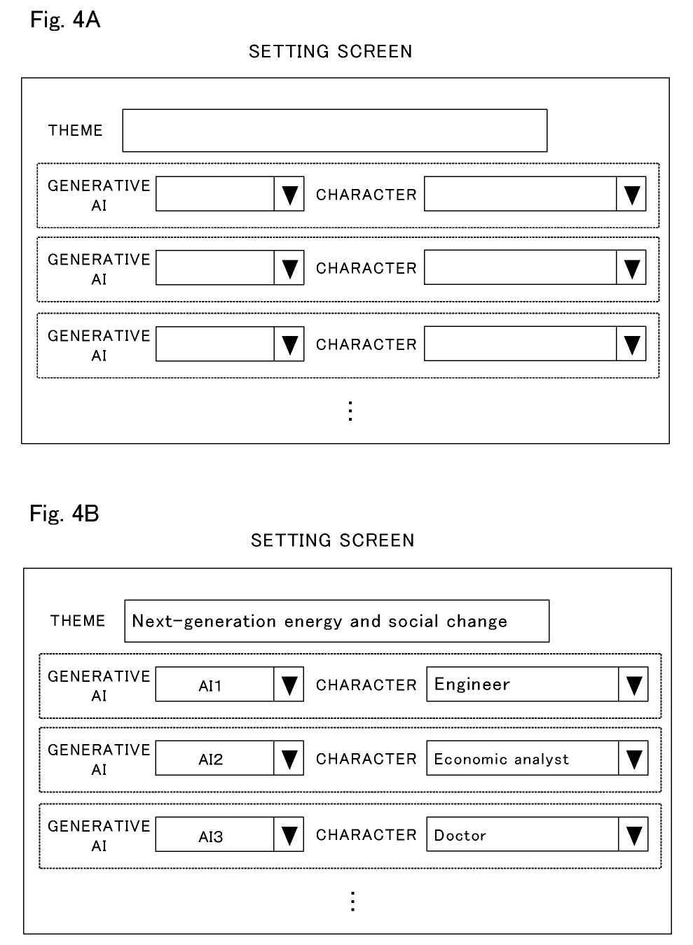

The setting information acquisition unit 41 acquires, from the user terminal 2, setting information such as the theme of the discussion set by the user, generative AIs to be used, and a character to be set for each generative AI. FIGS. 4A and 4B illustrate examples of a setting screen.

As illustrated in FIG. 4A, the setting screen includes a theme field, and a plurality of generative AI fields and character fields. The theme field is a field for setting the theme of the discussion. The user may freely input a theme, or may select a theme from a plurality of predetermined options. As an example, it is assumed that the user has set “Next-generation energy and social change” as the theme as illustrated in FIG. 4B.

The generative AI fields are fields for setting generative AIs to be used for the discussion. The user sets the generative AIs by selecting generative AIs from a list of options including a plurality of generative AIs or inputting any generative AIs on the setting screen. Specifically, the generative AIs are various types of interactive AIs utilizing LLMs such as ChatGPT, and may be specially caused to learn specialized knowledge in, for instance, medical care or laws. The generative AIs used for the discussion are not limited to interactive AIs, and it is possible to apply any generative AIs such as data analysis AIs that present statistical data or numerical grounds, for instance.

The character fields are fields for setting a character of each generative AI. In a discussion using a plurality of generative AIs, by setting a different role for each generative AI, it is possible to conduct a more multilateral and deeper discussion. The character is a role to be set for each generative AI, and examples of the character include an “engineer” who provides a technical perspective, an “economic analyst” who considers a market or economic impact, and a “doctor” and a “lawyer” who have specialized knowledge. The user sets the character by selecting a character from a list of options including a plurality of characters or inputting any character on the setting screen. A character such as a “chairperson” or a “moderator” may be set to advance the discussion.

As illustrated in FIG. 4A, there are sets of a generative AI field and a character field. As an example, as illustrated in FIG. 4B, it is assumed that the user has configured settings to conduct a discussion using a generative AI “AI1” to which a character “engineer” is set, a generative AI “AI2” to which a character “economic analyst” is set, and a generative AI “AI3” to which a character “doctor” is set. While three generative AIs are used in FIG. 4B, the present disclosure is not limited thereto, and the number of generative AIs to be used can be freely set.

The control unit 42 activates a plurality of generative AIs based on the setting information, and conducts a discussion. Specifically, the control unit 42 conducts the discussion by inputting, based on the setting information, a prompt including a directive for setting a character for each generative AI and a directive for requesting to draw a final outcome through repeated exchange of opinions on the theme. The directive for requesting the final outcome can be freely set in accordance with the theme.

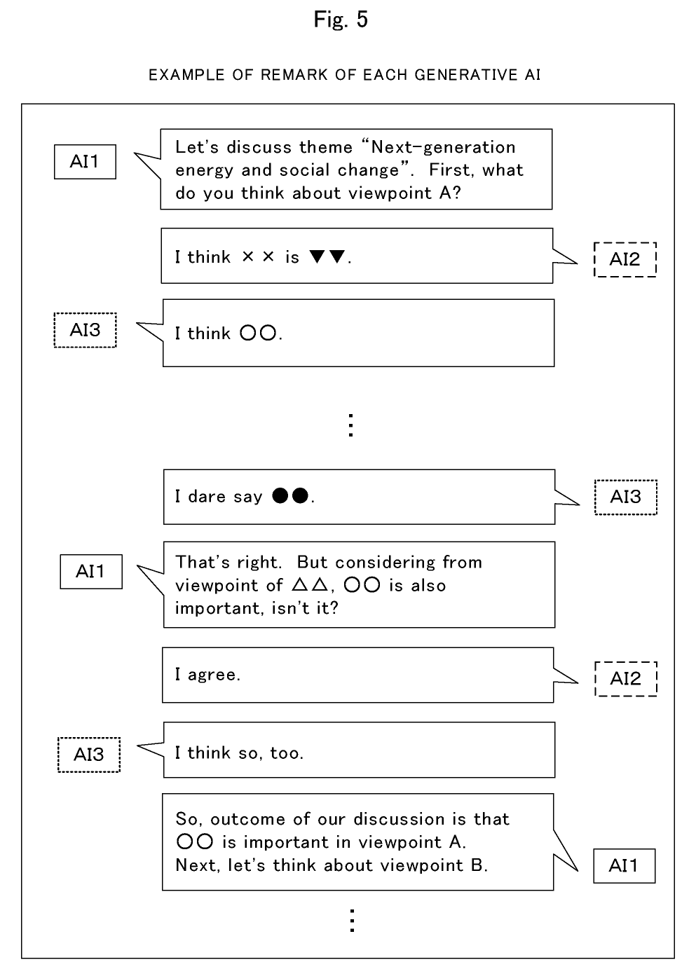

FIG. 5 illustrates remark examples of respective generative AIs in a discussion. The history recording unit 43 records the contents of remarks of each generative AI in a discussion using a plurality of generative AIs. Specifically, the history recording unit 43 records, as history information in the history recording DB 31, AI identification information for identifying the generative AIs used for the discussion, a character that is set for each generative AI, remarks of each generative AI and the times at which the remarks were made, and the like. The history recording unit 43 may record the theme of the discussion and the user identification information in association with the history information.

The setting recording unit 44 records the setting information set by the user in a discussion using a plurality of generative AIs. Specifically, the setting recording unit 44 records, as the setting information in the setting recording DB 32, a theme of the discussion, AI identification information of the generative AIs used for the discussion, a character that is set for each generative AI, and the like. The setting recording unit 44 may record user identification information of the user who has conducted the discussion, the degree of satisfaction of the discussion, the degree of contribution of each generative AI, and the like as part of the setting information.

The outcome specifying unit 45 specifies the outcome of the discussion based on the theme included in the setting information and the remarks of each generative AI. As an example, the outcome specifying unit 45 extracts a keyword indicating the outcome such as “conclusion”, “outcome”, and “summary” from the remarks of each generative AI, and specifies the outcome by analyzing context around the keyword. As another example, the outcome specifying unit 45 creates a prompt for requesting to specify the outcome based on the theme and the remarks of each generative AI, and specifies the outcome by inputting the prompt to a predetermined generative AI. In the example illustrated in FIG. 5, the outcome specifying unit 45 specifies the outcome of a viewpoint A as “○○ based on △△”. Specification of the outcome is not limited to these, and can be freely set.

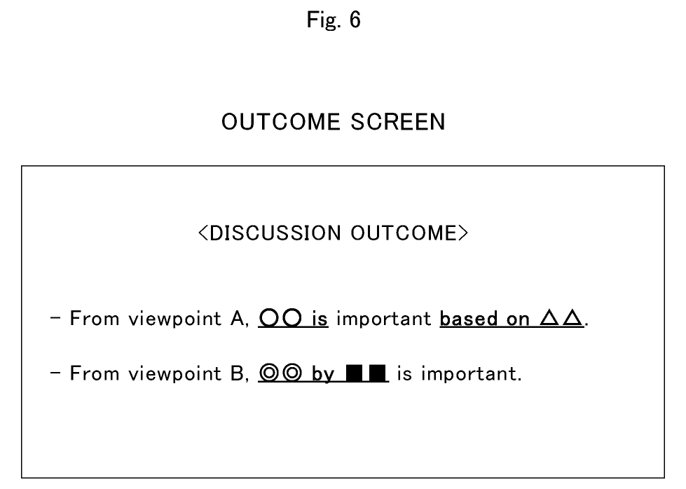

FIG. 6 illustrates an example of an outcome screen. As illustrated in FIG. 6, the outcome specifying unit 45 creates an outcome screen displaying the specified discussion outcome.

The contribution degree calculation unit 46 calculates the degrees of contribution indicating how the remarks of each generative AI have contributed to the outcome. The degree of contribution is a numerical value, and the higher the degree of contribution, the larger the numerical value, and the lower the degree of contribution, the smaller the numerical value. However, the degree of contribution is not limited thereto, and can be freely set to be indicated by, for instance, “high” or “low” without using numerical values.

As an example, the contribution degree calculation unit 46 calculates the degrees of similarity between the remarks of each generative AI and the outcome, and calculates the degrees of contribution based on the degrees of similarity. In this case, a remark having a higher degree of similarity with the outcome obtains a higher degree of contribution by the calculation. As another example, the contribution degree calculation unit 46 creates a prompt for requesting to calculate the degrees of contribution of the remarks of each generative AI based on the outcome, and calculates the degrees of contribution of the remarks of each generative AI by inputting the prompt to a predetermined generative AI. Calculation of the degrees of contribution is not limited to these, and can be freely set. The degrees of contribution of the remarks of each generative AI are associated with each generative AI and recorded in the setting recording DB 32 as part of the setting information.

The satisfaction degree acquisition unit 47 acquires, from the user terminal 2, the degree of satisfaction for an outcome input by the user through a predetermined operation as feedback of the user who has confirmed the outcome of the discussion. The degree of satisfaction of the discussion may be a numerical value such as a score input by the user, or may be a word selected from among “good”, “normal”, “bad”, and the like. The degree of satisfaction of the discussion is associated with the discussion and recorded in the setting recording DB 32 as part of the setting information.

The discussion information acquisition unit 48 acquires discussion information input in a case where a new discussion is conducted from a user terminal used by any user who uses the discussion support system 100. Specifically, the discussion information includes user identification information of the user who conducts a new discussion, a theme of the new discussion set on the setting screen, and the like, and is acquired in a case where any user sets information regarding the new discussion on the setting screen.

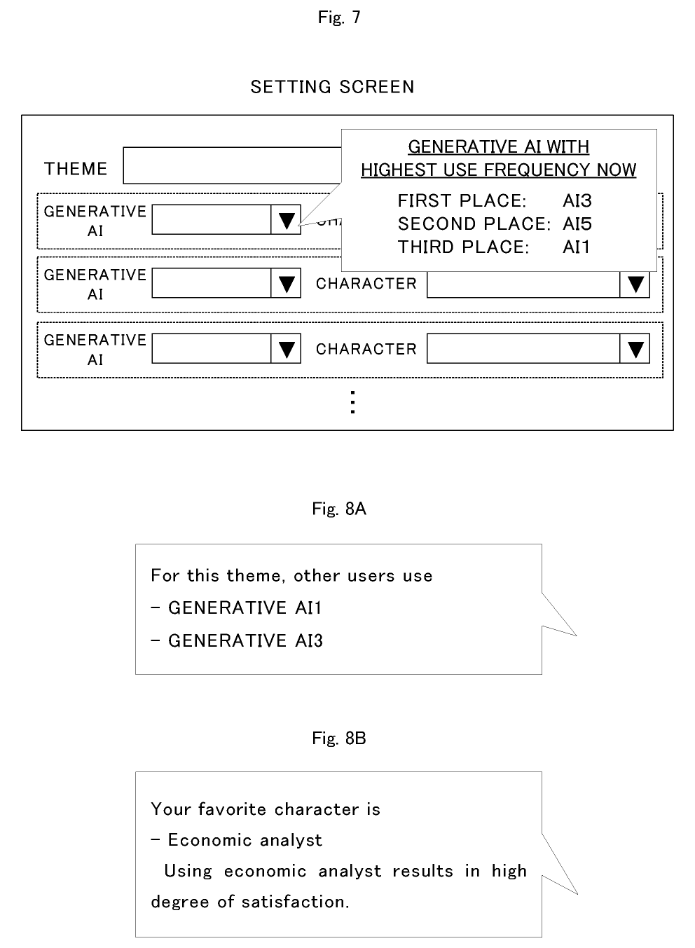

The recommended information creation unit 49 analyzes the setting information, and creates and outputs recommended information regarding a generative AI or character to be recommended to the user. As an example, the recommended information creation unit 49 analyzes the setting information, and creates and outputs information indicating a generative AI with the highest use frequency at that time. The recommended information may be in a ranking format. FIG. 7 illustrates an example of the setting screen displaying recommended information. Specifically, the recommended information creation unit 49 transmits the recommended information to the user terminal of the user who conducts a new discussion, and displays the ranking of the generative AIs as “generative AI with highest use frequency now” on the setting screen as illustrated in FIG. 7. As a result, the user who conducts the new discussion can select the generative AI to be used with reference to the recommended information.

In addition to the example illustrated in FIG. 7, the recommended information creation unit 49 analyzes the setting information, and creates and outputs information indicating the generative AI with the highest degree of satisfaction at that time, information indicating the generative AI with the highest degree of contribution at that time, and the like. The information indicating the generative AI with the high degree of satisfaction is created by extracting the generative AI used in the discussion with the high degree of satisfaction, based on the setting information.

Furthermore, the recommended information creation unit 49 analyzes the setting information, and creates and outputs information indicating the character with the highest setting frequency at that time, information indicating the character with the highest degree of satisfaction at that time, information indicating the character with the highest degree of contribution at that time, and the like. The information indicating the character with the high degree of satisfaction is created by extracting the character that is set for the generative AI used in the discussion with the high degree of satisfaction, based on the setting information. The information indicating the character with the high degree of contribution is created by extracting the character that is set for the generative AI with the high degree of contribution based on the setting information.

In a case where a theme (Hereinafter, it is referred to as a “new theme”.) of a new discussion is included in the discussion information, the recommended information creation unit 49 extracts a generative AI used for a theme similar to the new theme from the setting information, and creates and outputs, based on the extracted generative AI, information indicating a generative AI with high use frequency, information indicating a generative AI with the high degree of satisfaction, information indicating a generative AI with the high degree of contribution, and the like. For instance, as illustrated in FIG. 8A, the recommended information creation unit 49 creates and outputs recommended information such as “Other users use generative AI1 and generative AI3 for this theme.”.

Furthermore, the recommended information creation unit 49 extracts a generative AI used for a theme similar to the new theme from the setting information, and creates and outputs, based on the extracted generative AI, information indicating a character with high setting frequency, information indicating a character with the high degree of contribution, information indicating the generative AI with the high degree of satisfaction, and the like.

The recommended information creation unit 49 extracts a generative AI used by the same user from the setting information based on the user identification information included in the discussion information, and creates and outputs, based on the extracted generative AI, information indicating a generative AI with high use frequency, information indicating a generative AI with the high degree of contribution, information indicating a generative AI with the high degree of satisfaction, and the like.

The recommended information creation unit 49 extracts a generative AI used by the same user from the setting information based on the user identification information included in the discussion information, and creates and outputs information indicating a character with high setting frequency, information indicating a character with the high degree of satisfaction, information indicating a character with the high degree of contribution, and the like. For instance, as illustrated in FIG. 8B, the recommended information creation unit 49 creates and outputs recommended information such as “Your favorite character is economic analyst. Using economic analyst results in high degree of satisfaction.”.

The recommended information creation unit 49 may extract a generative AI used by the same user in a similar theme from the setting information based on the user identification information and the new theme included in the discussion information, and create the recommended information regarding the generative AI or the character.

In the above configuration, the setting information acquisition unit 41, the control unit 42, the history recording unit 43, the setting recording unit 44, the outcome specifying unit 45, the contribution degree calculation unit 46, the discussion information acquisition unit 48, and the recommended information creation unit 49 of the server 1 are examples of a setting information acquisition means, a control means, a setting recording means, an outcome specifying means, a contribution degree calculation means, a theme acquisition means, and a recommended information creation means, respectively, of the present disclosure.

### Recommended Information Creation Processing

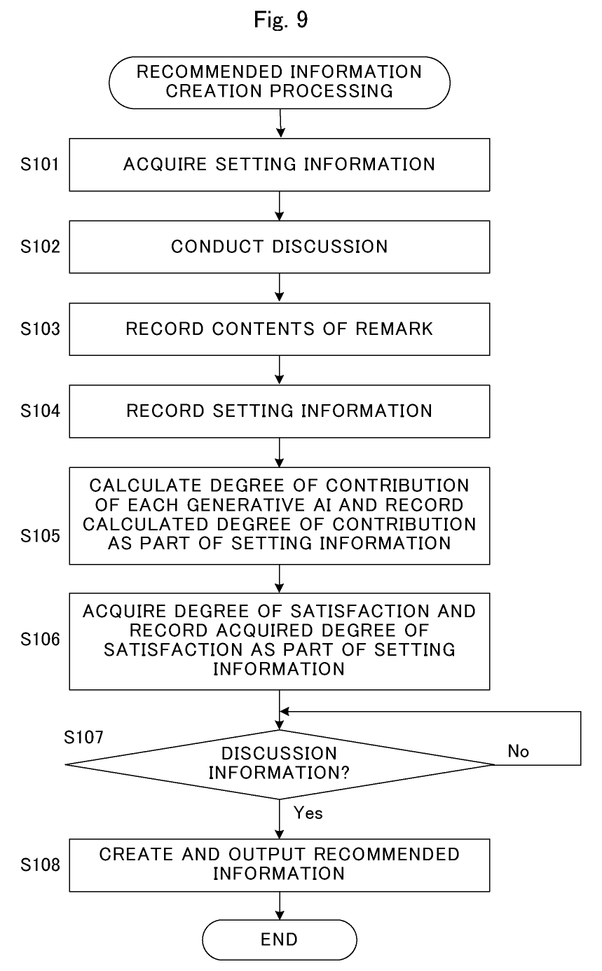

Next, recommended information creation processing by the server 1 will be described. FIG. 9 is a flowchart illustrating an example of the recommended information creation processing by the server 1. This processing is achieved by the processor 12 illustrated in FIGS. 2A and 2B executing a program prepared in advance.

First, the server 1 acquires setting information from the user terminal 2 (step S101). Next, the server 1 conducts a discussion using a plurality of generative AIs based on the setting information (step S102). The server 1 records the contents of remarks of each generative AI in the discussion as history information in the history recording DB 31 (step S103). In addition, the server 1 records the setting information set by the user in the setting recording DB 32 (step S104).

Next, the server 1 refers to the history recording DB 31 and specifies an outcome of the discussion based on the setting information and the remarks of each generative AI. Based on the specified outcome, the server 1 calculates the degree of contribution to the outcome of the remarks of each generative AI and records the calculated degree of contribution in the setting recording DB 32 as part of the setting information (step S105).

Next, the server 1 creates and outputs an outcome screen, and acquires the degree of satisfaction with the outcome of the discussion from the user terminal 2. The acquired degree of satisfaction is recorded in the setting recording DB 32 as part of the setting information (step S106).

Next, the server 1 determines whether discussion information input at the time of conducting a new discussion has been acquired (step S107). If it is determined that the discussion information has not been acquired (step S107; No), the server 1 stands by. On the other hand, if it is determined that the discussion information has been acquired (step S107; Yes), the server 1 creates recommended information and transmits the recommended information to a user terminal used by any user who conducts the new discussion (step S108). Thus, the recommended information creation processing terminates.

According to such a discussion support system 100, it is possible to utilize an outcome of a discussion using a plurality of generative AIs and obtained information regarding the generative AIs. Specifically, the discussion support system 100 can clarify selection criteria for a generative AI to be used in a next discussion, by providing recommended information to a user based on the information obtained by the discussion using the plurality of generative AIs. For instance, the user who newly conducts a discussion can use an efficient generative AI or set an appropriate character according to a theme with reference to the recommended information provided from the discussion support system 100.

### Modification Example

The server 1 may acquire a recommendation request input by the user through a predetermined operation from the user terminal 2, and create recommended information based on the recommendation request. The recommendation request includes information that the user wishes to be recommended. Specifically, the user selects, through the predetermined operation on the user terminal 2, any one or more of a generative AI and a character to be recommended, and transmits the selected generative AI and character to the server 1 as the recommendation request. The server 1 creates and outputs the recommended information. For instance, in a case where the generative AI is included in the recommendation request, the server 1 creates and outputs information indicating the generative AI with high use frequency, the generative AI with the high degree of satisfaction, the generative AI with the high degree of contribution, and the like as the recommended information.

Note that the recommendation request can be freely set, such as a generative AI used in a similar theme or a character with the high degree of satisfaction set by the user himself/herself in the past.

### Second Example Embodiment

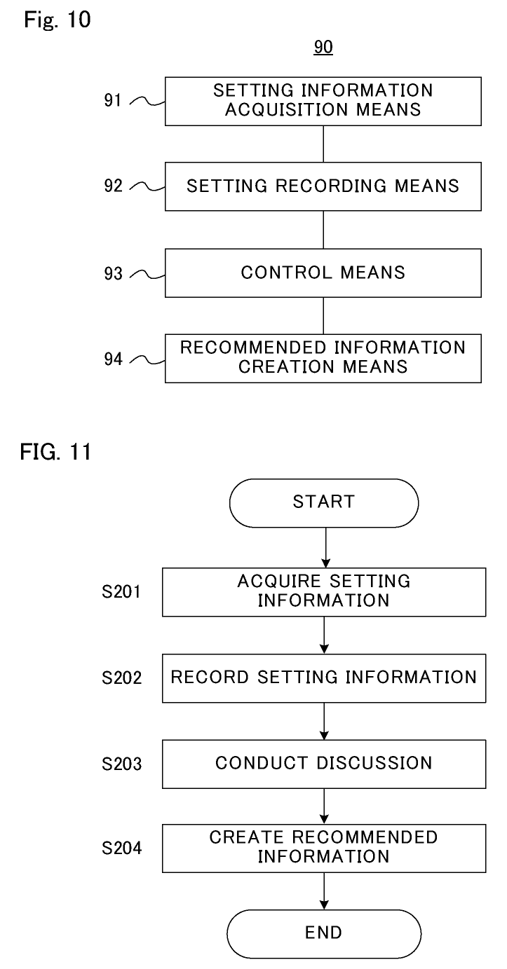

FIG. 10 is a block diagram illustrating an example of a functional configuration of a discussion support device according to the present disclosure. A discussion support device 90 includes a setting information acquisition means 91, a setting recording means 92, a control means 93, and a recommended information creation means 94.

FIG. 11 is a flowchart illustrating an example of processing by the discussion support device 90. The discussion support device 90 is communicably connected to a plurality of generative AIs. The setting information acquisition means 91 acquires setting information set by a user for a discussion (step S201). The setting recording means 92 records the setting information (step S202). The control means 93 activates a plurality of generative AIs based on the setting information and causes the plurality of generative AIs to conduct the discussion (step S203). The recommended information creation means 94 analyzes the setting information, and creates and outputs recommended information to be recommended to the user (step S204). According to the discussion support device 90, it is possible to provide a discussion support device capable of utilizing an outcome of a discussion using a plurality of generative AIs and obtained information regarding the generative AIs.

Additionally, some or all of the above example embodiments (including the modification example, the same applies below) may also be described as follows, but are not limited to the following.

### Supplementary Note 1

A discussion support device that is communicably connected to a plurality of generative AIs, the discussion support device including:
a setting information acquisition means configured to acquire setting information set by a user for a discussion;
a setting recording means configured to record the setting information;
a control means configured to activate the plurality of generative AIs based on the setting information and causing the plurality of generative AIs to conduct the discussion; and
a recommended information creation means configured to analyze the setting information, and create and output recommended information to be recommended to the user.

### Supplementary Note 2

The discussion support device according to Supplementary Note 1, wherein
the setting information includes information regarding a generative AI used for the discussion, and
the recommended information creation means creates, based on the setting information, information on a generative AI with high use frequency as the recommended information.

### Supplementary Note 3

The discussion support device according to Supplementary Note 2, wherein
the setting information includes information on a theme of the discussion,
the discussion support device comprises a theme acquisition means configured to acquire a new theme that is a theme of a new discussion input by the user, and
the recommended information creation means extracts a generative AI used for a theme similar to the new theme from the setting information and creates, based on the extracted generative AI, information on a generative AI with high use frequency as the recommended information.

### Supplementary Note 4

The discussion support device according to Supplementary Note 2, wherein
the setting information includes information on a theme and a degree of satisfaction of the discussion,
the discussion support device comprises a theme acquisition means configured to acquire a new theme that is a theme of a new discussion input by the user, and
the recommended information creation means extracts a generative AI used for a theme similar to the new theme from the setting information and creates, based on the extracted generative AI, information on a generative AI used in a discussion with a high degree of satisfaction as the recommended information.

### Supplementary Note 5

The discussion support device according to Supplementary Note 2, including:
a history recording means configured to record contents of a remark of each of the generative AIs in the discussion;
an outcome specifying means configured to analyze the remark of each of the generative AIs and specifying an outcome of the discussion;
a contribution degree calculation means configured to calculate a degree of contribution of the remark by each of the generative AIs based on the remark of each of the generative AIs and the outcome; and
a theme acquisition means configured to acquire a new theme that is a theme of a new discussion input by the user, wherein
the setting recording means records the degree of contribution of the remark by each of the generative AIs in association with the generative AI included in the setting information, and
the recommended information creation means extracts a generative AI used for a theme similar to the new theme from the setting information, and creates information on a generative AI with a high degree of contribution as the recommended information.

### Supplementary Note 6

The discussion support device according to Supplementary Note 2, wherein
the setting information includes information on a theme of the discussion,
the discussion support device comprises a theme acquisition means configured to acquire a new theme that is a theme of a new discussion input by the user, and
the recommended information creation means extracts a generative AI used for a theme similar to the new theme from the setting information and creates, based on a character that is set for the extracted generative AI, information indicating a character with high setting frequency as the recommended information.

### Supplementary Note 7

The discussion support device according to Supplementary Note 4, wherein
the setting information includes information on a theme and a degree of satisfaction of the discussion,
the discussion support device comprises a theme acquisition means configured to acquire a new theme that is a new theme input by the user, and
the recommended information creation means extracts a generative AI used for a theme similar to the new theme from the setting information and creates, based on a character that is set for the extracted generative AI, information on a character that is set in a discussion with a high degree of satisfaction as the recommended information.

### Supplementary Note 8

The discussion support device according to Supplementary Note 2, wherein
the setting information includes information for identifying a user who has conducted the discussion,
the discussion support device comprises a user acquisition means configured to acquire identification information of a user who conducts a new discussion, and
the recommended information creation means extracts a generative AI used by the user who conducts the new discussion from the setting information, and creates information on a generative AI with high use frequency by the user as the recommended information.

### Supplementary Note 9

A discussion support method executed by a discussion support device communicably connected to a plurality of generative AIs, the discussion support method including:
acquiring setting information set by a user for a discussion;
recording the setting information;
activating the plurality of generative AIs based on the setting information and causing the plurality of generative AIs to conduct the discussion; and
analyzing the setting information, and creating and outputting recommended information to be recommended to the user.

### Supplementary Note 10

A program executed by a discussion support device that is communicably connected to a plurality of generative AIs and includes a computer, the program causing the computer to execute processing including:
acquiring setting information set by a user for a discussion;
recording the setting information;
activating the plurality of generative AIs based on the setting information and causing the plurality of generative AIs to conduct the discussion; and
analyzing the setting information, and creating and outputting recommended information to be recommended to the user.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Furthermore, some or all of the configurations described as Supplementary Notes can be similarly dependent on not only Supplementary Notes 1, 9, and 10, but also various pieces of hardware and software, and various recording means or systems for recording software without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1 Server
2 User terminal
11, 21 Interface
12, 22 Processor
13, 23 Memory
14, 24 Recording medium
15, 25 Display unit
16, 26 Input unit
31 History recording DB
32 Setting recording DB
41 Setting information acquisition unit
42 Control unit
43 History recording unit
44 Setting recording unit
45 Outcome specifying unit
46 Contribution degree calculation unit
47 Satisfaction degree acquisition unit
48 Discussion information acquisition unit
49 Recommended information creation unit
100 Discussion support system

1. A discussion support device that is communicably connected to a plurality of generative AIs, the discussion support device comprising:
at least one memory configured to store instructions; and
at least one processor configured to execute the instructions to:
acquire setting information set by a user for a discussion;
record the setting information;
activate the plurality of generative AIs based on the setting information and causing the plurality of generative AIs to conduct the discussion; and
analyze the setting information, and create and output recommended information to be recommended to the user.

2. The discussion support device according to claim 1, wherein
the setting information includes information regarding a generative AI used for the discussion, and
the processor creates, based on the setting information, information on a generative AI with high use frequency as the recommended information.

3. The discussion support device according to claim 2, wherein
the setting information includes information on a theme of the discussion,
the processor is further configured to acquire a new theme that is a theme of a new discussion input by the user, and
the processor extracts a generative AI used for a theme similar to the new theme from the setting information and creates, based on the extracted generative AI, information on a generative AI with high use frequency as the recommended information.

4. The discussion support device according to claim 2, wherein
the setting information includes information on a theme and a degree of satisfaction of the discussion,
the processor is further configured to acquire a new theme that is a theme of a new discussion input by the user, and
the processor extracts a generative AI used for a theme similar to the new theme from the setting information and creates, based on the extracted generative AI, information on a generative AI used in a discussion with a high degree of satisfaction as the recommended information.

5. The discussion support device according to claim 2, wherein the processor is further configured to:
record contents of a remark of each of the generative AIs in the discussion;
analyze the remark of each of the generative AIs and specifying an outcome of the discussion;
calculate a degree of contribution of the remark by each of the generative AIs based on the remark of each of the generative AIs and the outcome; and
acquire a new theme that is a theme of a new discussion input by the user, wherein
the processor records the degree of contribution of the remark by each of the generative AIs in association with the generative AI included in the setting information, and
the processor extracts a generative AI used for a theme similar to the new theme from the setting information, and creates information on a generative AI with a high degree of contribution as the recommended information.

6. The discussion support device according to claim 2, wherein
the setting information includes information on a theme of the discussion,
the processor is further configured to acquire a new theme that is a theme of a new discussion input by the user, and
the processor extracts a generative AI used for a theme similar to the new theme from the setting information and creates, based on a character that is set for the extracted generative AI, information indicating a character with high setting frequency as the recommended information.

7. The discussion support device according to claim 4, wherein
the setting information includes information on a theme and a degree of satisfaction of the discussion,
the discussion support device comprises a theme acquisition means configured to acquire a new theme that is a new theme input by the user, and
the processor extracts a generative AI used for a theme similar to the new theme from the setting information and creates, based on a character that is set for the extracted generative AI, information on a character that is set in a discussion with a high degree of satisfaction as the recommended information.

8. The discussion support device according to claim 2, wherein
the setting information includes information for identifying a user who has conducted the discussion,
the processor is further configured to acquire identification information of a user who conducts a new discussion, and
the processor extracts a generative AI used by the user who conducts the new discussion from the setting information, and creates information on a generative AI with high use frequency by the user as the recommended information.

9. A discussion support method executed by a discussion support device communicably connected to a plurality of generative AIs, the discussion support method comprising:
acquiring setting information set by a user for a discussion;
recording the setting information;
activating the plurality of generative AIs based on the setting information and causing the plurality of generative AIs to conduct the discussion; and
analyzing the setting information, and creating and outputting recommended information to be recommended to the user.

10. A non-transitory computer-readable recording medium storing a program executed by a discussion support device that is communicably connected to a plurality of generative AIs and includes a computer, the program causing the computer to execute processing comprising:
acquiring setting information set by a user for a discussion;
recording the setting information;
activating the plurality of generative AIs based on the setting information and causing the plurality of generative AIs to conduct the discussion; and
analyzing the setting information, and creating and outputting recommended information to be recommended to the user.
